(19) United States
(12) Patent Application Publication
(10) Pub. No.: US 2017/0101050 A1
(43) Pub. Date: Apr. 13, 2017

(54) TRAFFIC PROMPTING SYSTEM FOR DRIVER

(71) Applicant: HON HAI PRECISION INDUSTRY CO., LTD., New Taipei (TW)

(72) Inventors: YU-CHEN HUANG, New Taipei (TW); KUN-MING LIN, New Taipei (TW)

(21) Appl. No.: 14/921,191

(22) Filed: Oct. 23, 2015

(30) Foreign Application Priority Data
Oct. 12, 2015 (CN) 201510656145.1

(51) Int. Cl. B60Q 1/34; G01S 19/42; G08B 23/00; G08G 1/09

(52) U.S. Cl. CPC B60Q 1/346; G08G 1/09; G01S 19/42; G08B 23/00

(57) ABSTRACT

A traffic prompting system for a car includes a processing unit. The processing unit includes a global positioning system (GPS) unit and a controller. The GPS unit is configured to detect whether the car is turning and to output a turning message. The controller is configured to receive the turning message from the GPS unit, and to control a turn light of the car to be lit according to the turning message. Therefore, the traffic prompting system can provide travelling message for a driver effectively and timely, which can make the driver safety.

### FIELD

The subject matter herein generally relates to a traffic prompting system for a driver.

### BACKGROUND

People usually see a screen of a global positioning system (GPS) in habit when in driving, especially in turning a corner, which is insecurity.

### BRIEF DESCRIPTION OF THE DRAWINGS

Implementations of the present technology will now be described, by way of example only, with reference to the attached figures.

FIG. 1 is a diagrammatic view of one embodiment of a traffic prompting system for a driver, wherein the traffic prompting system comprising a processing unit.

FIG. 2 is a block diagram of one embodiment of a processing unit of the traffic prompting system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

The disclosure will now be described in relation to a traffic prompting system for a driver.

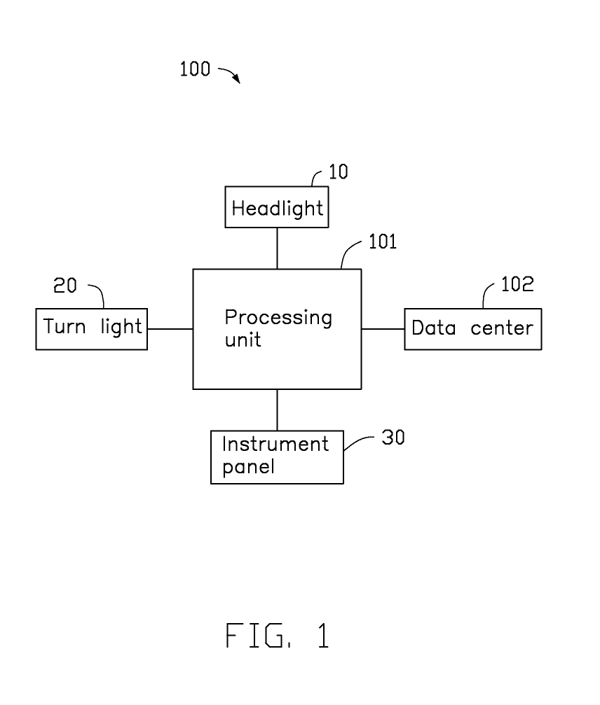

FIG. 1 illustrates diagrammatic view of one embodiment of a traffic prompting system 100 for a driver.

The traffic prompting system 100 can include, but not limited to, a processing unit 101, a headlight 10, a turn light 20, an instrument panel 30, and a data center 102. The headlight 10, the turn light 20, the instrument panel 30, and the data center 102 are electrically coupled to the processing unit 101. In at least one embodiment, the traffic prompting system 100 can be applied in a car, such as a motor vehicle.

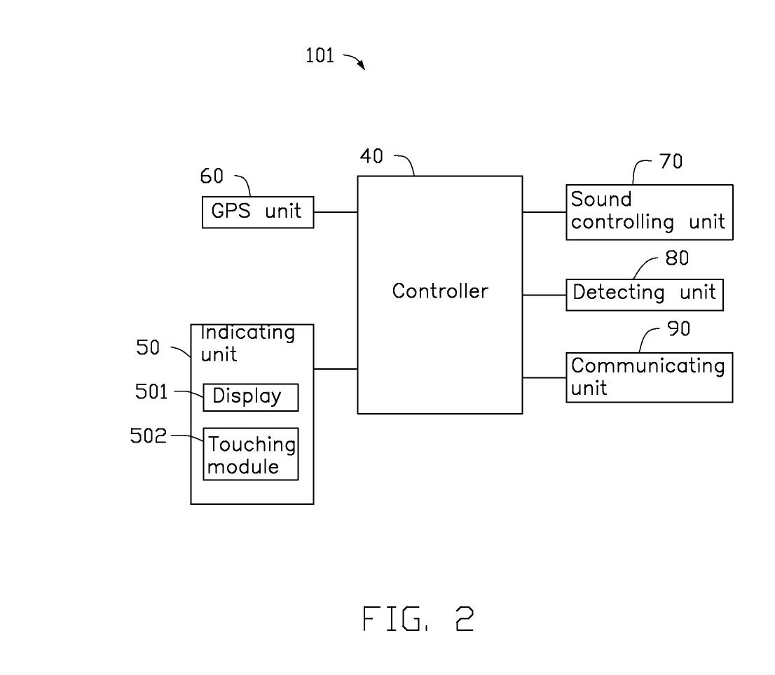

FIG. 2 illustrates block view of one embodiment of the processing unit 101. The processing unit 101 includes a controller 40, a indicating unit 50, a global positioning system (GPS) unit 60, a sound controlling unit 70, a detecting unit 80, and a communicating unit 90. In at least one embodiment, the indicating unit 50 includes a display 501 and a touching module 502. The display 501 is a color film in roll type. The touching module 502 is a soft touch film. The detecting unit 80 is electrically coupled to the headlight 10, the turn light 20, and the instrument panel 30, for detecting whether any of the headlight 10, the turn light 20, and the instrument panel 30 is in fault. The controller 40 can receive a detection result from the detecting unit 80. If the either one of the headlight 10, the turn light 20, and the instrument panel 30 is in fault, the controller 40 controls the display 501 to show an alarm message, to prompt the driver to repair the car rapidly.

The GPS unit 60 can be configured to detect whether the car is turning, and can output a turning message to the processing unit 40. The processing unit 40 can receive a feedback message from the GPS unit 60, and can control the turn light 20 to be lit according to the feedback message. Of course, the processing unit 90 can control the turn light 20 to be lit through controlling the indicating unit 50 to flicker.

The sound controlling unit 70 is configured to set a navigate message of the GPS unit 60 by receiving a voice from the driver. The touching module 502 is configured to setting the navigate message of the GPS unit 60 through the display 501. When the GPS unit 60 operates, the processing unit 40 controls the sound controlling unit 70 to operate, to receive a voice message from the driver for adjusting the navigate message of the GPS unit 60, and controls the touching module 502 to shut down simultaneously for avoiding a danger of outputting a navigate message to set the GPS unit 60.

When the processing unit 40 detects the car is static, the processing unit 40 controls the touching module 502 to operate, to make the driver to set the navigate message through the touching module 502. The communicating unit 90 is configured to transmit a travelling message of the car to the data center 102. Therefore, the driver can monitor the travelling message of the car through the data center 102.

Therefore, the traffic prompting system 100 can provide travelling message for driver effectively and timely, which can make the driver safety.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A traffic prompting system processing unit for a car comprising:
a global positioning system (GPS) unit configured to detect whether the car is turning and to output a turning message; and
a controller configured to receive the turning message from the GPS unit and to control a turn light of the car to be activated according to the turning message.

2. The traffic prompting system according to claim 1, wherein the processing unit further comprises an indicating unit, when the GPS unit detects the car turning, the controller controls the indicating unit to twinkle

3. The traffic prompting system according to claim 2, wherein the controller can be also configured to detect whether the turn light is abnormal, if the turn light is abnormal, the controller the indicating unit to show an alarm message.

4. The traffic prompting system according to claim 3, wherein the indicating unit comprises a display and a touching module, the display is configured to display travelling message and the alarm message, the touching module is configured to set a navigate message of the GPS unit.

5. The traffic prompting system according to claim 4, wherein the processing unit comprises a sound controlling unit; when the GPS unit operates, the processing unit controls the sound controlling unit operating to receive a voice message from a driver for adjusting a navigate message of the GPS unit, and controls the touching module to shut down simultaneously.

6. The traffic prompting system according to claim 5, wherein when the processing unit detects the car is static, the processing unit controls the touching module to operate, to make the driver to set the navigate message through the touching module.

7. The traffic prompting system according to claim 6, further comprise a data center, wherein the processing unit comprises a communicating unit, the processing unit is configured to transmit the travelling message of the car to the data center.

8. The traffic prompting system according to claim 3, wherein the display is a color film in roll type.

9. The traffic prompting system according to claim 3, wherein the touching module is a soft touch film.
